(19) United States
(12) Patent Application Publication
(10) Pub. No.: US 2009/0319989 A1
(43) Pub. Date: Dec. 24, 2009

(54) MODIFICATION OF SOFTWARE AT RUNTIME

(76) Inventors: Russ Osterlund, Merrimack, NH (US); David Sleeper, Meredith, NH (US)

Correspondence Address: LAW OFFICES OF TIMOTHY BRISSON, 340 GRASS VALLEY HIGHWAY, AUBURN, CA, 95603, US

(21) Appl. No.: 12/404,186

(22) Filed: Mar. 13, 2009

Related U.S. Application Data
(60) Provisional application No. 61/069,650, filed on Mar. 13, 2008.

(51) Int. Cl. G06F 9/44

(52) U.S. Cl. 717/114

(57) ABSTRACT

Disclosed are techniques for injecting one or more additional modules into a starting Windows process and ensuring that these modules are loaded and initialized at the earliest possible time by the Windows loader. The technique reuses the Windows loader by intercepting the normal loading of initial and subsequent module loads by the process at a single well-defined point in the loader. Methods for identifying and locating binary constructs using binary construct signatures are also disclosed.

### CROSS-REFERENCE TO RELATED APPLICATIONS

This application claims priority to U.S. Provisional Application 61/069,650, filed Mar. 13, 2008, which is incorporated by reference herein as though fully set forth.

### FIELD OF THE DISCLOSURE

This disclosure relates to operating systems, in particular, to providing multi-user functionality in single-user operating systems.

### BACKGROUND OF THE INVENTION

Normal documented techniques of loading additional modules designed to monitor and change code and data flow in a Windows process can be employed only well after a program has started and any required initialization of code has taken place; this results in the potential of missing many important events and the chance to alter the early process environment.

If another mechanism can be found that guarantees the early load of a module, then the Windows loader will then as part of normal processing initialize the module earlier than documented techniques. The code can then establish its monitors earlier and miss fewer of these early events. Furthermore, if the mechanism can leverage existing code in the Windows loader, the inevitable disruption in normal processing can be kept to a minimum, reducing bugs and any unintended side effects.

### BRIEF DESCRIPTION OF DRAWINGS

FIG. 1 is a diagram showing the functional relationship between the Windows Loader and thunks in accordance with this disclosure; and

FIG. 2 is a flowchart of a method of identifying and locating binary constructs using binary construct signatures according to the present disclosure.

### DETAILED DESCRIPTION

The LdrpWalkImportDescriptor Hook of the present disclosure accomplishes the goal by intercepting the Windows loader's call that recursively walks statically-linked modules embedded inside of Windows modules (the import table) and by adding an additional module load via a call to LdrLoadDll. In effect, a new virtual entry has been added to the program's module import table containing the additional module. Once the load is finished and the import table walk finished, the first hook is replaced with a second hook at this same point whose purpose is to capture any subsequent module loads and to permit patches and other variables to be setup in these new modules.

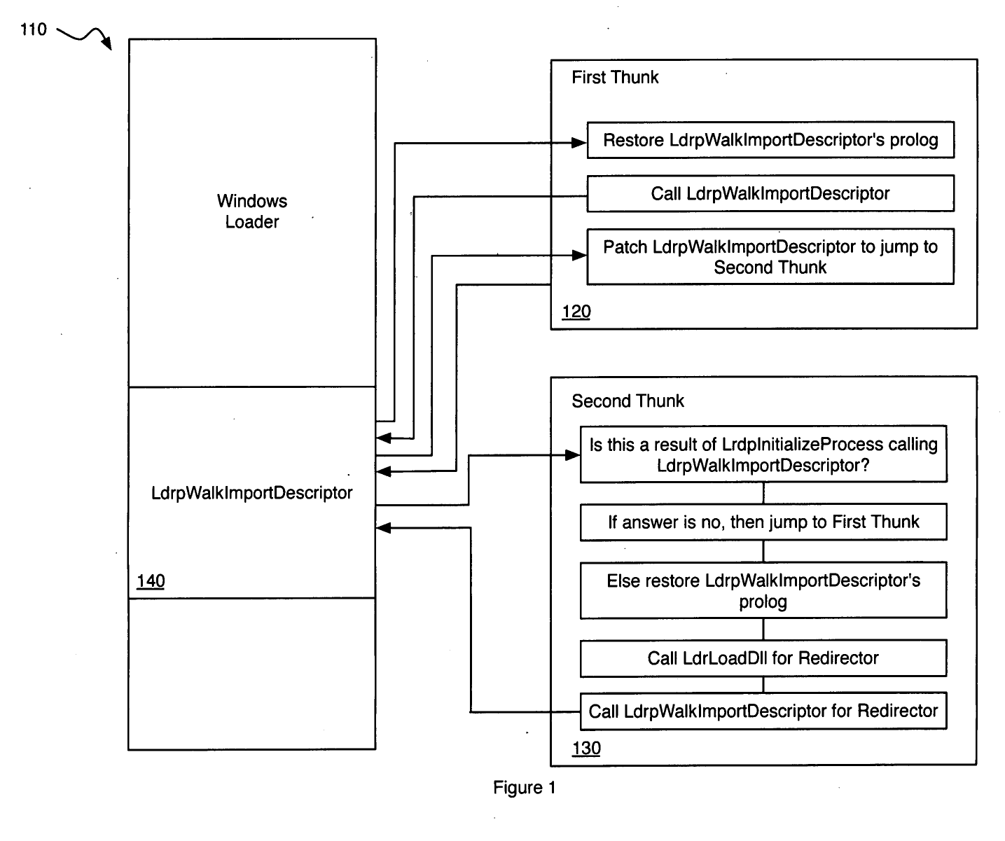

FIG. 1 is a diagram showing the functional relationship between the Windows Loader 110, and how the first thunk 120 and second thunk 130 interact with the LrdpWalkImportDescriptor 140 in the present disclosure. Before the LrdpWalkImportDescriptor 140 process has been loaded into memory, but before it is executed, code that has the functionality described in the first thunk 120 is written into the beginning of the LrdpWalkImportDescriptor 140 function.

Thus, the first time the system calls the LrdpWalkImportDescriptor 140 function, instead of executing the LrdpWalkImportDescriptor 140 function's normal code, the code associated with first thunk 120 is executed.

When the first thunk 120 is executed, the instructions are restored to the LrdpWalkImportDescriptor 140 function that was overwritten above. Then the LrdpWalkImportDescriptor 140 function is called, which is then executed as it normal would be. Finally, a patch is inserted into the LrdpWalkImportDescriptor 140 function to call the second thunk 130.

Therefore, the next time the system calls the LrdpWalkImportDescriptor 140, the second thunk 130 restores the original instructions to the beginning of the LrdpWalkImportDescriptor 140 function.

Then, the LdrLoadDll is called for the module that is being injected into the process, thereby loading the called dll into the process. Finally, LrdpWalkImportDescriptor 140 is called again, walking through the redirector module and initializing the appropriate dependencies.

As will now be appreciated, the first thunk 120 allows the KRNL32.DLL to initialize, and the second thunk 130 allows the initialization of the rest of the modules.

Also contained within the current disclosure is a method for determining the address of undocumented, internal functions and variables in executable files at runtime. In this method, symbol files for existing versions of an executable are used to create signatures of variables and functions that can later be used to locate said variables and functions within new versions of the executable, without the use of symbol files; symbol files are used initially, to develop the signatures, but the method does not require the symbols to locate the internal variables and functions at runtime.

Additionally, embodiments are disclosed for determining the addresses of an undocumented, internal functions and variables contained within executable files and libraries. It is contemplated that the addresses of functions and variables will change across versions because of added/deleted functionality, refactoring of existing code, use of different compilers and compiler options, etc.

Because executable modules follow a documented specification (e.g., the PE specification), their structure will provide known entry and references points, e.g. exports, imports, the entry-point. There are also interrelationships between modules, e.g., NTOSKRNL/NTDLL and WIN32K/USER32/GDI32 that provide additional known locations. And as the addresses of functions and variables are located, these new addresses provide additional reference points that can be used to find the locations of other functions and variables.

The development of a signature relies on a library that provides access to the structure of the PE modules and that disassembles and collects instructions belonging to individual functions. From the function collections, call-trees, data and code flow, and parameter counts can be derived, further enhancing the tools available in the library. The development process also uses publicly available debug symbols to develop, document and debug signatures (although for reasons cited earlier, these symbols cannot be used at runtime). Access to many samples of the core modules to verify correctness of signatures is employed to insure accuracy of each algorithm's results. Finally, if no function or variable is found that matches the set of attributes described by the signature, a zero is returned indicating failure (rather than attempting to rediscover at run-time the address through a fuzzy heuristic or probe). It is desired that there be no false positives.

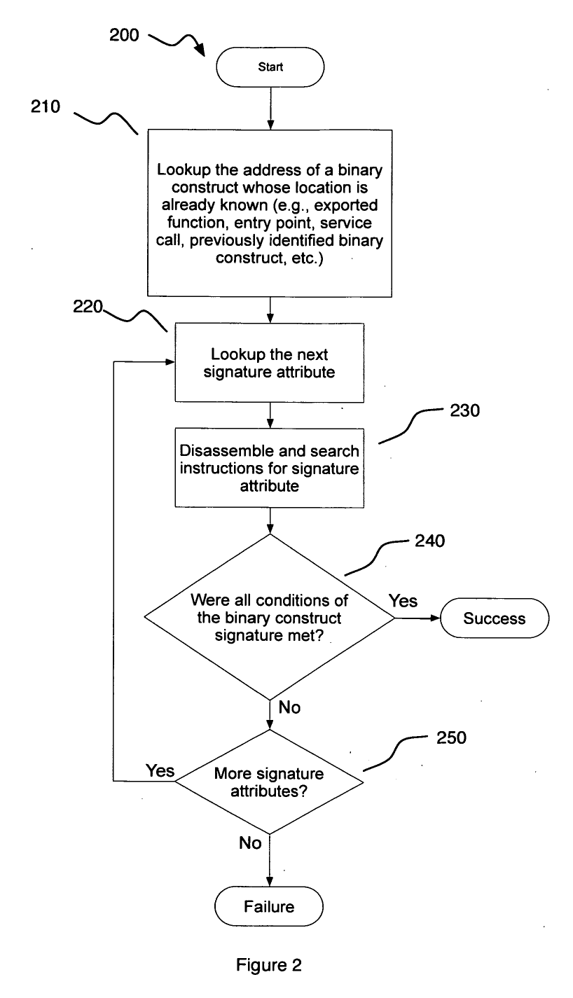

FIG. 2 is a flowchart of a method 200 of identifying and locating binary constructs (e.g., functions and variables) using binary construct signatures according to the present disclosure.

As used herein, a programming-language construct refers to a syntactic structure or set of structures in the source code of a computer program that define and manipulate the program's data structures or control its flow of execution. Examples include: classes, name spaces, functions, variables, objects, data types, declarations, conditions, name spaces, keywords, operators, exceptions and statements.

A binary construct refers to the machine code or byte code that was generated from a programming-language construct.

A signature attribute refers to a characteristic of a binary construct or a relationship between a binary construct and one or more other binary constructs that can be used to identify the construct. Examples of signature attributes include: references to variables, function parameter counts, calls to functions, lack of calls to functions, calls from functions, call graph structures, instruction types, and sequences of operations.

The process begins in act 210, where the address of a binary construct whose location is already known is looked up. (e.g., exported function, entry point, service call, previously identified binary construct, etc.)

In act 220, the next signature attribute is looked up. It is contemplated that signature attributes for various binary constructs may be stored for retrieval and modification by the system of this disclosure.

The system disassembles and searches machine code for signature attributes in act 230.

In query 240, the signature attributes retrieved in act 220 are compared against the results of act 230. The signature attributes are compared to determine whether a match has been found based upon the attribute comparison and whether all of the conditions of the binary construct signature have been met.

If all of the conditions of the binary construct signature have been met, the process continues in query 250 if any more signature attributes are left to identify, and the process returns to act 220.

Otherwise, the process may end.

While embodiments and applications of this invention have been shown and described, it will now be apparent to those skilled in the art having the benefit of this disclosure that many more modifications than mentioned above are possible without departing from the inventive concepts disclosed herein.

1. A method for identifying and locating binary constructs using binary construct signatures, comprising:
looking up the address of a binary construct whose location within an executable module is already known; and
disassembling and searching instructions within said module for signature attributes;
